(19) United States
(12) Patent Application Publication
(10) Pub. No.: US 2025/0168046 A1
(43) Pub. Date: May 22, 2025

(54) PROCESSING METHOD, COMMUNICATION DEVICE AND STORAGE MEDIUM

(71) Applicant: SHENZHEN TRANSSION HOLDINGS CO., LTD., Shenzhen (CN)

(72) Inventors: Rongchang ZHU, Shenzhen (CN); Wei HUANG, Shenzhen (CN); Chiunwei HUANG, Shenzhen (CN)

(73) Assignee: SHENZHEN TRANSSION HOLDINGS CO., LTD., Shenzhen (CN)

(21) Appl. No.: 19/023,175

(22) Filed: Jan. 15, 2025

Related U.S. Application Data
(63) Continuation of application No. PCT/CN2022/113660, filed on Aug. 19, 2022.

(51) Int. Cl. H04L 27/26; H04L 5/00; H04W 72/23; H04W 72/40

(52) U.S. Cl. CPC H04L 27/2607; H04L 5/0007; H04W 72/23; H04W 72/40

(57) ABSTRACT

Disclosed are a processing method, a communication device and a storage medium. The method selects or determines a cyclic prefix extension based on a preset parameter, generates an orthogonal frequency division multiplexing symbol based on the cyclic prefix extension, communicates based on the orthogonal frequency division multiplexing symbol, generates an orthogonal frequency division multiplexing symbol according to the cyclic prefix extension, and uses the generated orthogonal frequency division multiplexing symbol for sidelink transmission, which helps to reserve channel occupancy time and can increase the probability of occupying unlicensed spectrum during sidelink transmission.

### CROSS-REFERENCE TO RELATED APPLICATIONS

This application is a continuation application of International Application No. PCT/CN2022/113660, filed on Aug. 19, 2022, the content of which is incorporated herein by reference in its entirety.

### TECHNICAL FIELD

The present application relates to the technical field of communication, and in particular to a processing method, a communication device and a storage medium.

### BACKGROUND

During sidelink transmission, there is usually a gap symbol at the end of the subframe structure for Tx/Rx switching (and switching to uplink (UL) transmission through timing advance (TA) when user equipment (UE) accesses the network by Radio Resource Control (RRC)). In addition, there is also a gap symbol when the transmitting terminal shares Channel Occupancy Time (COT) with the receiving terminal to allow it to send the physical sidelink feedback channel (PSFCH). For the subcarrier spacing of 15 kHz or 30 kHz supported in FR1, its symbol length is always greater than 25 μs.

During the process of conceiving and implementing this application, the inventor found that there are at least the following problems: in the unlicensed spectrum, if the interval between two adjacent transmissions is greater than 25 μs, the latter transmission cannot share the COT used by the previous transmission, that is, the latter transmission needs to use Type 1 Channel access, which will reduce the probability of the latter transmission occupying the unlicensed spectrum.

The preceding description is intended to provide general background information and does not necessarily constitute related art.

### SUMMARY

The main purpose of the present application is to provide a processing method, a communication device and a storage medium, aiming to increase the probability of occupying unlicensed spectrum during sidelink transmission.

In order to achieve the above objective, the present application provides a processing method, which can be applied to a terminal device (such as a mobile phone), including following steps:
S1: selecting or determining a cyclic prefix extension based on a preset parameter, generating an orthogonal frequency division multiplexing symbol based on the cyclic prefix extension, and communicating based on the orthogonal frequency division multiplexing symbol.

In an embodiment, the preset parameter includes at least one of the following: a number of symbols, a timing advance, a propagation delay, and a gap value.

In an embodiment, before the step S1, the method further includes: selecting or determining at least one of the following: the number of symbols, the timing advance, the propagation delay, and the gap value.

In an embodiment, a way of selecting or determining the number of symbols includes at least one of the following:
selecting or determining the number of symbols based on sidelink control information;
selecting or determining the number of symbols based on downlink control information;
selecting or determining the number of symbols based on common sidelink control information; and
selecting or determining the number of symbols based on a subcarrier spacing of a current sidelink Bandwidth Part and/or a sidelink resource pool.

In an embodiment, the timing advance includes a first timing advance and/or a second timing advance for two adjacent transmissions, and a way of selecting or determining the timing advance includes at least one of the following:
selecting or determining the first timing advance based on at least one of a sidelink radio resource control signaling, a medium access control-control element and sidelink control information sent by the first terminal;
selecting or determining the first timing advance and/or the second timing advance based on a medium access control-control element sent by the network device (such as a base station); and
selecting or determining the second timing advance based on a random access response message sent by the network device (such as a base station).

In an embodiment, a way of selecting or determining the propagation delay includes at least one of the following:
selecting or determining the propagation delay based on radio resource control signaling;
selecting or determining the propagation delay based on a preset fixed value; and
selecting or determining the propagation delay based on a first signal.

In an embodiment, the selecting or determining the gap value includes at least one of the following:
selecting or determining the gap value based on sidelink control information;
selecting or determining the gap value based on downlink control information; and
selecting or determining the gap value based on a preset configuration.

The present application further provides a processing method, which can be applied to a terminal device (such as mobile phone), including following steps:
S10: sending a first message, where the first message is configured to select or determine a first parameter, and the first parameter is configured to select or determine a cyclic prefix extension.

In an embodiment, the first message includes at least one of the following: sidelink control information, common sidelink control information, a sidelink radio resource control signaling, and a sidelink medium access control-control element; and/or, the first parameter includes at least one of the following: a number of symbols, a first timing advance, and a gap value.

In an embodiment, after sending the first message, the method further includes:

in response to the number of symbols being greater than a preset threshold, discarding symbol(s) of a previous transmission in two adjacent transmissions.

In an embodiment, the method further includes:
sending a first signal, where the first signal is configured to select or determine a propagation delay.

In an embodiment, before sending the first message, the method further includes:
selecting or determining the first message based on a second message.

The present application further provides a processing method, which can be applied to a network device (such as a base station), including following steps:
A10, sending a second message, where the second message is configured to select or determine a second parameter, and the second parameter is configured to select or determine a cyclic prefix extension.

In an embodiment, the second message includes at least one of the following: downlink control information, a medium access control-control element, a random access response message; and/or the second parameter includes at least one of the following: a number of symbols, a timing advance, and a gap value.

In an embodiment, the timing advance includes a first timing advance and/or a second timing advance for two adjacent transmissions.

The present application further provides a communication device, including: a memory, a processor, and a processing program stored on the memory and executable on the processor, and the processing program implements the processing method as described above when executed by the processor.

The communication device in the present application can be a terminal device (such as a mobile phone) or a network device (such as a base station). The specific reference needs to be clarified based on the context.

The present application further provides a storage medium, a computer program is stored on the storage medium, and the computer program implements the processing method as described above when executed by the processor.

In the present application, a cyclic prefix extension is selected or determined based on a preset parameter, an orthogonal frequency division multiplexing symbol is generated based on the cyclic prefix extension, and communicate based on the orthogonal frequency division multiplexing symbol. By generating an orthogonal frequency division multiplexing symbol according to the cyclic prefix extension and using the generated orthogonal frequency division multiplexing symbol for sidelink transmission, it helps to reserve the channel occupancy time and can increase the probability of occupying unlicensed spectrum during sidelink transmission.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of hardware structure of a terminal for implementing various embodiments of the present application according to an embodiment of the present application.

FIG. 2 is a diagram of architecture of a communication network system according to an embodiment of the present application.

FIG. 3 is a schematic diagram of hardware structure of a controller 140 according to the present application.

FIG. 4 is a schematic diagram of hardware structure of a network node 150 according to the present application.

FIG. 5 is a schematic flowchart of a processing method according to an embodiment of the present application.

FIG. 6 is a first principle schematic diagram of a processing method according to an embodiment of the present application.

FIG. 7 is a second principle schematic diagram of a processing method according to an embodiment of the present application.

FIG. 8 is a schematic flowchart of a processing method according to an embodiment of the present application.

FIG. 9 is a schematic flowchart of a processing method according to an embodiment of the present application.

FIG. 10 is a schematic flowchart of a processing method according to an embodiment of the present application.

FIG. 11 is a schematic flowchart of a processing method according to an embodiment of the present application.

FIG. 12 is a first principle schematic diagram of a processing method according to an embodiment of the present application.

FIG. 13 is a second principle schematic diagram of a processing method according to an embodiment of the present application.

FIG. 14 is a schematic structural diagram of a processing device according to an embodiment of the present application.

FIG. 15 is a schematic structural diagram of a processing device according to an embodiment of the present application.

FIG. 16 is a schematic structural diagram of a processing device according to an embodiment of the present application.

FIG. 17 is a schematic structural diagram of a communication device according to an embodiment of the present application.

The realization of the purpose, functional features and advantages of the present application will be further described with reference to the embodiments and the accompanying drawings. Through the above-mentioned drawings, clear embodiments of the present application have been shown, which will be described in more detail below. These drawings and text descriptions are not intended to limit the scope of the present application's concepts in any way, but are intended to illustrate the present application's concepts for those skilled in the art with reference to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S0 and S1 are used for the purpose of expressing the corresponding content more clearly and concisely, and do not constitute a substantive limitation on the order. Those skilled in the art may perform S1 first and then S0 etc. during specific implementation, but these should all be within the protection scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context.

In an embodiment, the terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

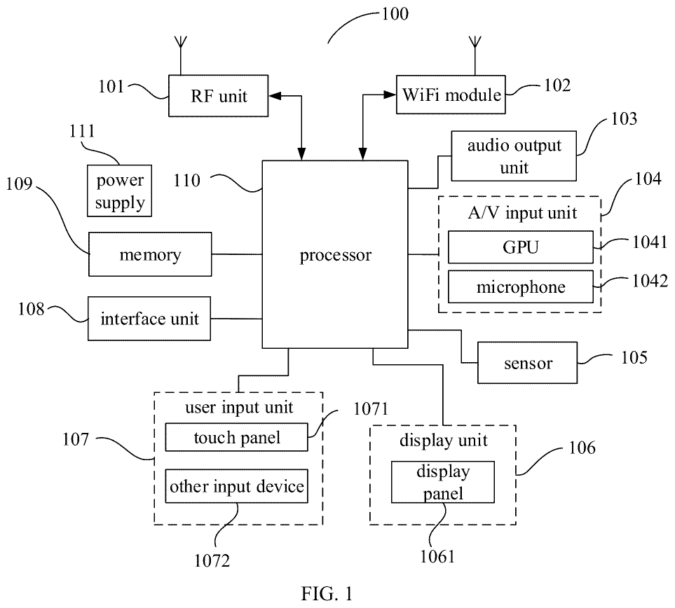

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switching, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated here.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and sends it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

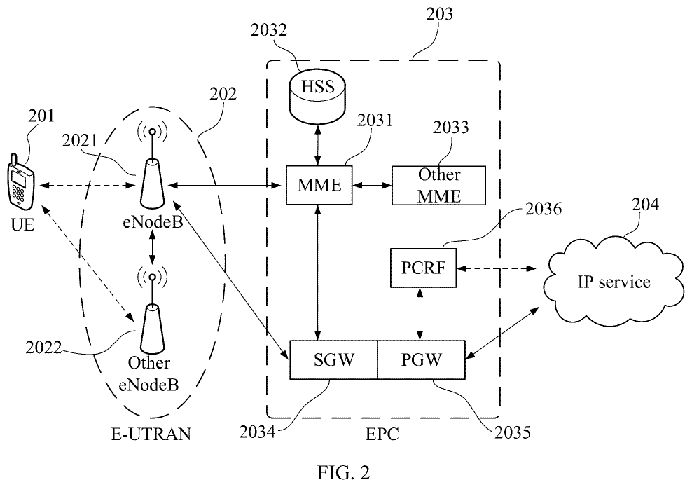

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

In an embodiment, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 5G), or the like, which is not limited herein.

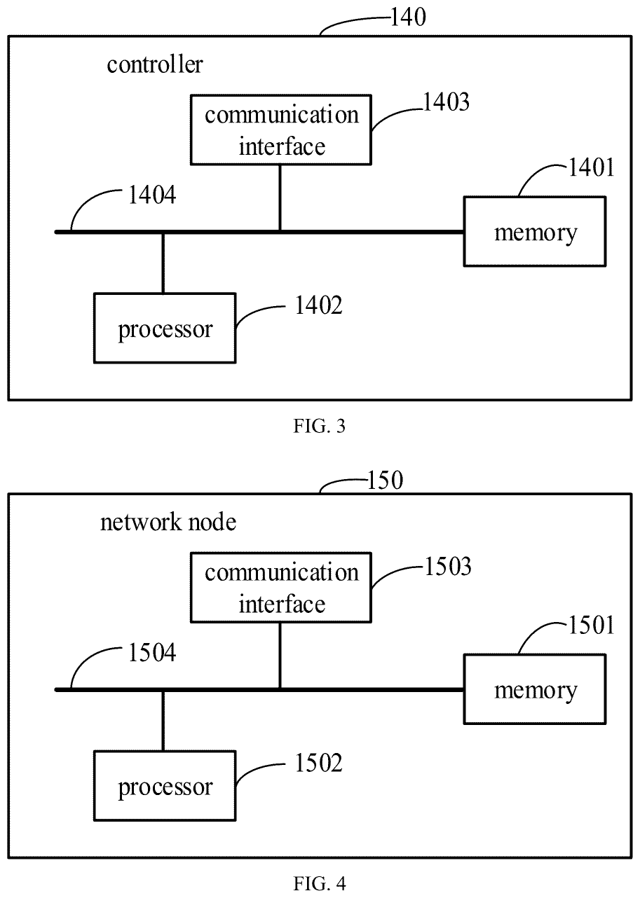

FIG. 3 is a schematic diagram of a hardware structure of a controller 140 according to the present application. The controller 140 includes a memory 1401 and a processor 1402, and the memory 1401 stores program instructions, and the processor 1402 calls the program instructions in the memory 1401 to execute the steps performed by the controller in the above method embodiment, and its implementation principle and beneficial effects are similar, which will not be repeated herein.

In an embodiment, the above controller further includes a communication interface 1403, which can be connected to the processor 1402 through a bus 1404. The processor 1402 can control the communication interface 1403 to realize the receiving and sending functions of the controller 140.

FIG. 4 is a schematic diagram of a hardware structure of a network node 150 according to the present application. The network node 150 includes a memory 1501 and a processor 1502, the memory 1501 stores program instructions, and the processor 1502 calls the program instructions in the memory 1501 to execute the steps performed by the network device in the above-mentioned method embodiment, and its implementation principle and beneficial effects are similar, which will not be repeated herein.

In an embodiment, the above-mentioned network node further includes a communication interface 1503, and the communication interface 1503 can be connected to the processor 1502 through a bus 1504. The processor 1502 can control the communication interface 1503 to realize the receiving and sending functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

In the above embodiments, it can be implemented in whole or in part by software, hardware, firmware, or any combination thereof. When implemented using software, it may be implemented in whole or in part in the form of a computer program product. The computer program product includes one or more computer instructions. When computer program instructions are loaded and executed on a computer, processes or functions according to embodiments of the present application are generated in whole or in part. The computer may be a general purpose computer, a special purpose computer, a computer network, or other programmable device. The computer instruction may be stored in or transmitted from one computer-readable storage medium to another computer-readable storage medium. For example, the computer instruction may be transmitted by wired (e.g., coaxial cable, optical fiber, digital subscriber line) or wireless (e.g., infrared, wireless, microwave, etc.) means from one website, computer, server, or data center to another website, computer, server, or data center. Computer-readable storage media can be any available media that can be accessed by a computer or a data storage device such as a server, data center, or other integrated media that contains one or more available media. Available media may be magnetic media (e.g., floppy disk, storage disk, tape), optical media (e.g., DVD), or semiconductor media (e.g., Solid State Disk (SSD)), etc.

Based on the above-mentioned mobile terminal hardware structure and communication network system, various embodiments of the present application are proposed.

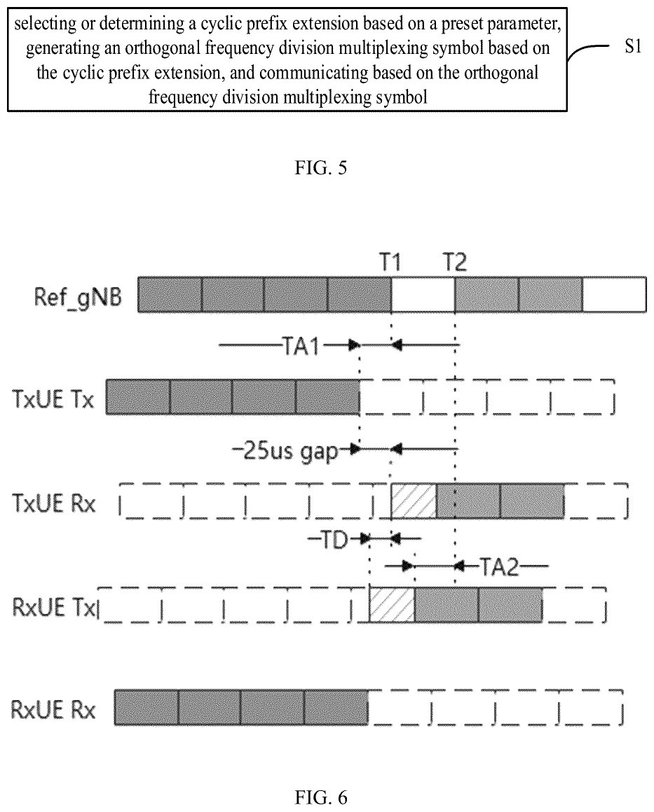

As shown in FIG. 5, FIG. 5 is a schematic flowchart of a processing method according to an embodiment of the present application. The method of the embodiment of the present application can be applied to a terminal device (such as a mobile phone, a car, etc.). The processing method includes the following steps:
S1: selecting or determining a cyclic prefix extension based on a preset parameter, generating an orthogonal frequency division multiplexing symbol based on the cyclic prefix extension, and communicating based on the orthogonal frequency division multiplexing symbol.

In an embodiment of the present application, channel occupancy time (COT) sharing can be further aided by using cyclic prefix extension (CPE), where the transmitting node uses it to take advantage of the COT, preventing it from being idle for too long and losing access to an unlicensed channel, which ensures that the interval between two transmissions meets regulations, enabling COT sharing.

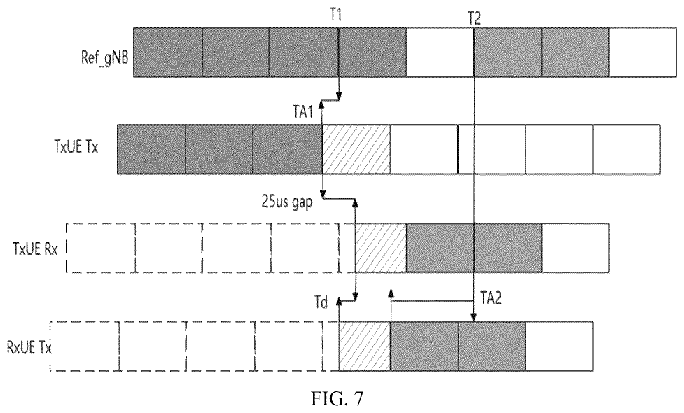

In an embodiment, during the sidelink transmission, the time domain reference point of the terminal sending the sidelink channel is the downlink slot from the base station, and the terminal selects the timing advance (TA) between the terminal and the base station as the timing advance (TASL) sent on the sidelink. Referring to FIG. 6 and FIG. 7, FIG. 6 is a first principle schematic diagram of a processing method according to an embodiment of the present application, and FIG. 7 is a second principle schematic diagram of a processing method according to an embodiment of the present application. As shown in the Figure, the transmitting terminal uses TA₁ as the timing advance when transmitting the physical sidelink control channel (PSCCH) and/or the physical sidelink shared channel (PSSCH), and the receiving terminal uses TA₂ as the timing advance when transmitting the physical sidelink feedback channel (PSFCH). If the transmitting terminal wishes to share the COT initiated by it with the receiving terminal, from the perspective of the transmitting terminal, the preset interval between the control channel/shared channel sent by the transmitting terminal and the feedback channel it receives should be equal to 16/25 μs and/or other fixed values, the values of these fixed values are natural numbers, and the units of these fixed values are microseconds.

Similarly, if the transmitting terminal shares the COT initiated by it with the receiving terminal, and the receiving terminal uses the COT to send the physical sidelink control channel and/or the physical sidelink shared channel, then from the perspective of the transmitting terminal, the interval between the physical sidelink control channel and/or the physical sidelink shared channel sent by the transmitting terminal and the physical sidelink control channel and/or the physical sidelink shared channel sent by the receiving terminal should be equal to 16/25 μs and/or other fixed values, the values of these fixed values are natural numbers, and the units of these fixed values are microseconds.

Similarly, if the first transmitting terminal shares the COT initiated by it with the second transmitting terminal, the second transmitting terminal uses the COT to send at least one of the physical sidelink control channel and/or the physical sidelink shared channel, the physical sidelink feedback channel, the sidelink synchronization signal/physical sidelink broadcast channel block (S-SS/PSBCH block), and the sidelink channel state information reference signal (SL-CSI-RS), from the perspective of the first transmitting terminal, the interval between at least one of the physical sidelink control channel and/or physical sidelink shared channel, physical sidelink feedback channel, sidelink synchronization signal/physical sidelink broadcast channel block (S-SS/PSBCH block), and sidelink channel state information reference signal (SL-CSI-RS) sent by the first transmitting terminal and at least one of the physical sidelink control channel and/or physical sidelink shared channel, physical sidelink feedback channel, sidelink synchronization signal/physical sidelink broadcast channel block (S-SS/PSBCH block), and sidelink channel state information reference signal (SL-CSI-RS) sent by the second transmitting terminal should be equal to 16/25 μs and/or other fixed values, the values of these fixed values are natural numbers, and the units of these fixed values are microseconds.

In order to ensure that the interval between the physical sidelink control channel and/or physical sidelink shared channel sent by the transmitting terminal and the physical sidelink feedback channel sent by the receiving terminal is equal to the preset interval, in the embodiment of the present application, taking the preset interval of 16 μs or 25 μs as an example, the receiving terminal performs cyclic prefix extension (CPE) on the first symbol of the physical sidelink feedback channel and/or the physical sidelink control channel and/or the physical sidelink shared channel and/or S-SS/PSBCH block and/or the symbol before the first symbol of the channel. When using cyclic prefix extension, it is necessary to determine the length of the cyclic prefix extension, that is, select or determine the cyclic prefix extension based on the preset parameter.

In an embodiment, the preset parameter includes at least one of the following: a number of symbols, a timing advance, a propagation delay, and a gap value.

In an embodiment of the present application, the length of CPE T_{CPE} can be obtained by the following equation:

$${T}_{1} - {TA}_{1} + {T}_{gap} = {T}_{2} - {TA}_{2} - {T}_{CPE} + {T}_{d}$$

T₁ is the end time of transmission of the transmitting terminal, T₂ is the start time of transmission of the receiving terminal, TA₁ is the timing advance of the transmitting terminal, TA₂ is the timing advance of the receiving terminal, and T_{d} is the propagation delay of the signal on the Tx-Rx link.

Through conversion, the following can be obtained:

$${T}_{CPE} = ( {T}_{2} - {T}_{1} ) - ( {TA}_{2} - {TA}_{1} ) + {T}_{d} - {T}_{gap} = {\sum }_{{0}^{Ci}} {T}_{sym} - ( {TA}_{2} - {TA}_{1} ) + {T}_{d} - {T}_{gap} = {\sum }_{{0}^{Ci}} {T}_{sym} - ( ( {TA}_{2} - {TA}_{1} ) - {T}_{d} + {T}_{gap} )$$

T_{sym} is the symbol length, Cᵢ is the number of symbols, T_{gap} is the gap value,

TA₁=(N_{TA,SL}+N_{TA,offset})·T_{c};TA₂=(N_{TA,SL}+N_{TA,offset})·T_{c}

N_{TA,SL} is the sidelink timing advance parameter, which is provided by (medium access control layer control element (MAC-CE) or random access response (RAR); N_{TA,offset} is the timing advance offset, which is provided by high-level signaling or predefined; time domain unit T_{c}=1/(Δ_{fax}·N_{f}), where Δfₘₐₓ=480-10³ Hz, N_{f}=4096.

In an embodiment, for the next transmission, in order to determine the size T_{CPE} of CPE, at least the following information needs to be obtained:

Number of symbols Cᵢ; Timing advance TA (including the timing advance TA₁ corresponding to the previous transmission and/or the timing advance TA₂ corresponding to the next transmission); Propagation delay T_{d}; Gap value T_{gap}.

In an embodiment, before the step S1, the method further includes: selecting or determining at least one of the following: number of symbols, timing advance, propagation delay, gap value, that is, including at least one of the following steps:
Step S01: selecting or determining the number of symbols;

In an embodiment, the number of symbols can be selected or determined based on the sidelink control information.

In an embodiment, the number of symbols can be selected or determined based on the downlink control information.

In an embodiment, the number of symbols can be selected or determined based on the common sidelink control information.

In an embodiment, the number of symbols can be selected or determined based on the subcarrier spacing of the current sidelink Bandwidth Part (BWP) and/or the sidelink resource pool. For example, when the subcarrier spacing is 15 kHz and 30 kHz, Cᵢ is equal to 1; when the subcarrier spacing is 60 kHz, Cᵢ is equal to 2.

Step S02: selecting or determining the timing advance.

In an embodiment, the timing advance includes a first timing advance and/or a second timing advance for two adjacent transmissions.

In an embodiment, the first timing advance can be selected or determined based on at least one of the sidelink radio resource control signaling, the medium access control-control element and the sidelink control information sent by the first terminal.

In an embodiment, the first terminal is a terminal that sends the previous transmission of two adjacent transmissions.

In an embodiment, the first timing advance and/or the second timing advance can be selected or determined based on the medium access control-control element sent by a network device (such as a base station).

In an embodiment, the second timing advance can be selected or determined based on a random access response sent by a network device (such as a base station).

In an embodiment, the first timing advance and/or the second timing advance is a fixed value, the fixed value is a natural number, and the unit of the fixed value is microseconds.

In an embodiment, the difference between the first timing advance and the second timing advance is a preset value, that is, the first timing advance can be calculated according to the second timing advance. The preset value can be indicated by at least one of the sidelink radio resource control signaling, the medium access control-control element, the sidelink control information and the random access response. The preset value can be used as one of the parameters for selecting or determining the cyclic prefix extension.

In an embodiment, the first timing advance is applied to the first transmission of two adjacent transmissions.

In an embodiment, the second timing advance is applied to the second transmission of two adjacent transmissions.

In an embodiment, the timing advance is indicated by at least one of the sidelink radio resource control signaling, the medium access control-control element, the sidelink control information and the random access response.

Step S03: selecting or determining the propagation delay.

In an embodiment, the propagation delay can be selected or determined based on the radio resource control signaling, the preset fixed value and/or the first signal.

In an embodiment of the present application, the propagation delay is the delay of the signal propagating between the transmitting terminal and the receiving terminal, and/or the delay of the signal propagating between the first transmitting terminal and the second transmitting terminal. Regarding the propagation delay, considering that the sidelink is mainly applied in two scenarios, one is the indoor scenario, the distance between the terminals is small, and the corresponding propagation delay is also small; the other is the highway scenario, the distance between the terminals is large, and the corresponding propagation delay is also large.

In an embodiment, the propagation delay can be disabled through Radio Resource Control (RRC) signaling, that is, the cyclic prefix extension calculation does not need to consider the propagation delay.

In an embodiment, a fixed propagation delay value is used, such as 1 μs, 2 μs, etc.

In an embodiment, the receiving terminal and/or the second transmitting terminal corresponding to the next transmission needs to estimate the propagation delay based on the received signal. The signal is sent by the first transmitting terminal corresponding to the previous transmission, and the signal may be at least one of a demodulation reference signal (DMRS) of a physical sidelink control channel (PSCCH), a DMRS of a physical sidelink shared channel (PSSCH), a sidelink synchronization signal/physical sidelink broadcast channel block (S-SS/PSBCH block), and a channel state information-reference signal (CSI-RS).

Step S04: selecting or determining the gap value.

In an embodiment, the gap value can be selected or determined based on the sidelink control information, downlink control information and/or preset configuration.

In the embodiment of the present application, for the gap value, its value is 16 us and/or 25 us, which can be dynamically indicated by SCI.

In an embodiment, if the subsequent transmission is a physical sidelink feedback channel sent by the receiving terminal, the number of symbols, gap value and other parameters can be indicated by the sidelink control information (SCI).

In an embodiment, if the subsequent transmission is at least one of the physical sidelink control channel and/or physical sidelink shared channel, physical sidelink feedback channel, sidelink synchronization signal/physical sidelink broadcast channel block (S-SS/PSBCH block), and sidelink channel state information-reference signal (SL-CSI-RS) sent by the second transmitting terminal, the number of symbols, gap value and other parameters can be indicated by the base station sending downlink control information (DCI).

In an embodiment, the above parameters, such as the number of symbols and the gap value, can also be jointly indicated by SCI, such as configuring a table, see Table 1, each row in the table represents a value of the above parameters. The table can be configured through RRC signaling.

TABLE 1
First configuration table

| Tₑₓₜ index i | Cᵢ | Δᵢ |
|---|---|---|
| 0 | — | — |
| 1 | C₁ | 25 · 10⁻⁶ |
| 2 | C₂ | 16 · 10⁻⁶ + T_{TA} |
| 3 | C₃ | 25 · 10⁻⁶ + T_{TA} |

In an embodiment, after selecting or determining the cyclic prefix extension based on preset parameters, an orthogonal frequency division multiplexing (OFDM) symbol can be generated based on the cyclic prefix extension. For an OFDM symbol using cyclic prefix extension, adding the length of CPE before the cyclic prefix (CP) can generate an OFDM symbol, and communication can be performed based on the OFDM symbol.

In this embodiment, through the above solution, selecting or determining a cyclic prefix extension based on the number of symbols, timing advance, propagation delay and/or gap value, and then generating an orthogonal frequency division multiplexing symbol based on the cyclic prefix extension, and communicating based on the orthogonal frequency division multiplexing symbol, helps to reserve channel occupancy time and can increase the probability of seizing unlicensed spectrum during sidelink transmission.

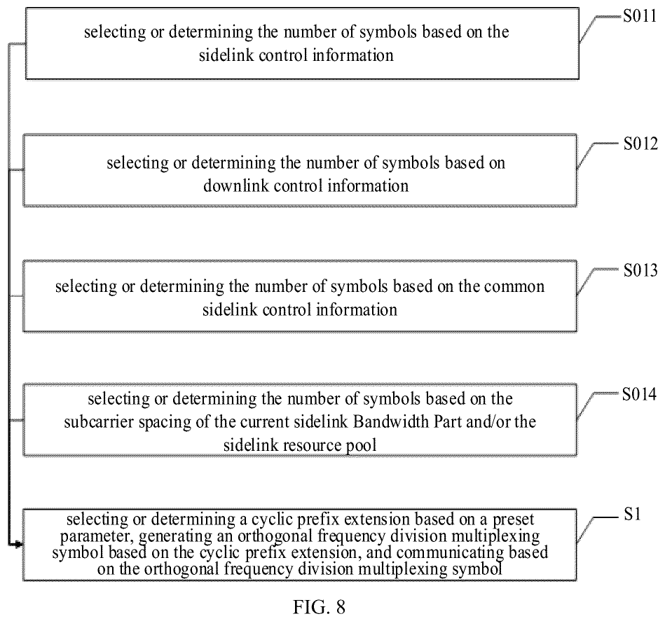

As shown in FIG. 8, FIG. 8 is a flowchart of a processing method according to an embodiment of the present application. Based on the above embodiments of the present application, this embodiment discloses a method for selecting or determining the number of symbols in step S01, which includes at least one of the following:
S011: selecting or determining the number of symbols based on the sidelink control information.

In an embodiment, the number of symbols Cᵢ can be dynamically indicated by the sidelink control information (SCI). In an embodiment, a field is added to the SCI format to indicate the number of symbols required for the cyclic prefix. For example, 2 bits are added, and the field points to Table 1. In an embodiment, the Cᵢ values in the table are C₁, C₂, and C₃, C₁=1 for tE-{0,1}, C₁=2 for μ=2; C₂ and C₃ are configured by RRC signaling, and their values are {1, . . . , 28}. In an embodiment, when the subcarrier spacing is 15 kHz, the values of C₂ and C₃ are {1, . . . , 28}; when the subcarrier spacing is 30 kHz, the value of C₂ is {1, . . . , 28}, and the value of C₃ is {2, . . . , 28}; when the subcarrier spacing is 60 kHz, the value of C₂ is {2, . . . , 28}, and the value of C₃ is {3, . . . , 28}.

In an embodiment, the sidelink control information is carried in the physical sidelink control channel and is sent by the first transmitting terminal. The first transmitting terminal is the terminal that sends the previous transmission of two adjacent transmissions.

In an embodiment, the first transmitting terminal is the terminal that initiates COT.

S012: selecting or determining the number of symbols based on downlink control information.

In an embodiment, the number of symbols Cᵢ can be dynamically indicated by the downlink control information (DCI), and in an embodiment, a field is added to the DCI format, and the field is used to indicate the number of symbols required for the cyclic prefix. For example, 2 bits are added, and the field points to Table 1. When the first transmitting terminal receives the DCI, the content in the corresponding SCI is set according to the indication in the DCI, and the SCI is sent to the receiving terminal and/or the second transmitting terminal.

In an embodiment, when the receiving terminal and/or the second transmitting terminal receives the DCI, the number of symbols is selected or determined according to the indication in the DCI.

S013: selecting or determining the number of symbols based on the common sidelink control information.

In an embodiment, the number of symbols Cᵢ can be dynamically indicated by the common sidelink control information (common SCI), and the common SCI is used to indicate at least one of the COT length, COT remaining time, COT switching point, number of symbols Cᵢ, channel access type, etc.

S014: selecting or determining the number of symbols based on the subcarrier spacing of the current sidelink Bandwidth Part and/or the sidelink resource pool.

In an embodiment, the symbol number Cᵢ is associated with the subcarrier spacing of the current sidelink Bandwidth Part (BWP) and/or the sidelink resource pool. For example, when the subcarrier spacing is 15 kHz and 30 kHz, Cᵢ is equal to 1; when the subcarrier spacing is 60 kHz, Cᵢ is equal to 2.

In an embodiment, when the symbol number Cᵢ is greater than 1, the first transmitting terminal discards the last Cᵢ-1 symbols of the last transmission.

In this embodiment, through the above solution, the number of symbols is selected or determined based on the sidelink control information, downlink control information, common sidelink control information, the current sidelink Bandwidth Part and/or the subcarrier spacing of the sidelink resource pool, and then the cyclic prefix extension is selected or determined according to the number of symbols to generate orthogonal frequency division multiplexing symbols, and then the sidelink channel transmission is performed based on the orthogonal frequency division multiplexing symbols, which helps to reserve the channel occupancy time and improve the probability of occupying the unlicensed spectrum during the sidelink transmission process.

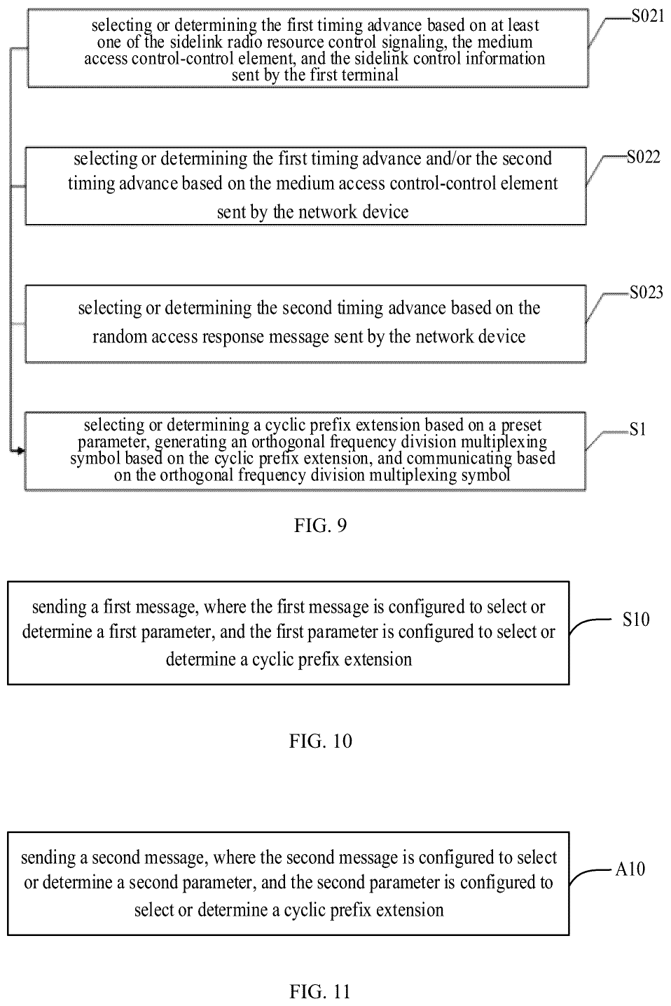

As shown in FIG. 9, FIG. 9 is a schematic flowchart of a processing method according to an embodiment of the present application. Based on the above embodiments, this embodiment discloses a method for selecting or determining a timing advance in step S02. The timing advance includes a first timing advance and/or a second timing advance for two adjacent transmissions. The way for selecting or determining the timing advance includes at least one of the following:

S021: selecting or determining the first timing advance based on at least one of the sidelink radio resource control signaling, the medium access control-control element, and the sidelink control information sent by the first terminal.

For the first timing advance TA₁ corresponding to the previous transmission, the first timing advance TA₁ is the timing advance used for the transmission of the transmitting terminal. The timing advance is equal to TA₁=(N_{TA,SL}+N_{TA,offset})·T_{c}, where N_{TA,SL} can be equal to the timing advance N_{TA1} of the uplink of the currently operating cell, N_{TA}=T_{A}·16·64/2^{μ}, T_{A} is obtained through the random access response (RAR) message or MAC-CE. N_{TA,offset} is obtained through RRC signaling indication, or is obtained according to the pre-defined value.

In an embodiment, N_{TA,SL} can be equal to zero.

In an embodiment, TA₁ may notify the receiving terminal and/or the second transmitting terminal corresponding to the next transmission through the sidelink radio resource control signaling (SL-RRC) sent by the first transmitting terminal corresponding to the previous transmission.

In an embodiment, TA₁ may notify the receiving terminal and/or the second transmitting terminal corresponding to the next transmission through the medium access control-control element (MAC-CE) sent by the first transmitting terminal corresponding to the previous transmission.

In an embodiment, TA₁ may notify the receiving terminal and/or the second transmitting terminal corresponding to the next transmission through the sidelink control information (SCI) sent by the first transmitting terminal corresponding to the previous transmission.

S022: selecting or determining the first timing advance and/or the second timing advance based on the medium access control-control element sent by the network device.

For the second timing advance TA₂ corresponding to the next transmission, the second timing advance TA₂ is the timing advance used for the transmission of the receiving terminal/or the second transmitting terminal. The time advance is equal to TA₂=(N_{TA,SL}+N_{TA,offset})·T_{c}, N_{TA,SL} can be equal to the timing advance N_{TA2} of the uplink of the currently operating cell. N_{TA}=T_{A}·16·64/2^{μ}. T_{A} is obtained through RAR message or MAC-CE. N_{TA,offset t is obtained through RRC signaling indication or is obtained according to the pre-defined value. The next transmission sent by the receiving terminal is the physical sidelink feedback channel (PSFCH).}

In an embodiment, the second timing advance TA₂ is the timing advance used for transmission of the second transmitting terminal, and the second transmitting terminal shares the COT used by the transmitting terminal. The next transmission sent by the second transmitting terminal is at least one of a physical sidelink control channel and/or a physical sidelink shared channel, a physical sidelink feedback channel, a sidelink synchronization signal/physical sidelink broadcast channel block (S-SS/PSBCH block), and a sidelink channel state information reference signal (SL-CSI-RS).

In an embodiment, N_{TASL} can be equal to zero.

In an embodiment, TA₁ can notify the receiving terminal and/or the second transmitting terminal corresponding to the next transmission through the medium access control-control element (MAC-CE) sent by the base station.

In an embodiment, when the transmitting terminal side TA₁ is updated, the updated TA₁ needs to be synchronously notified to the receiving terminal and/or the second transmitting terminal corresponding to the next transmission.

In an embodiment, TA₂ can notify the receiving terminal and/or the second transmitting terminal corresponding to the next transmission through the medium access control-control element (MAC-CE) sent by the base station.

S023: selecting or determining the second timing advance based on the random access response message sent by the network device.

In an embodiment, TA₂ can notify the receiving terminal and/or the second transmitting terminal corresponding to the next transmission through a random access response (RAR) message sent by the base station.

In an embodiment, the first timing advance and/or the second timing advance is a fixed value, the fixed value is a natural number, and the unit of the fixed value is microseconds.

In an embodiment, the difference between the first timing advance and the second timing advance is a preset value, that is, the first timing advance can be calculated according to the second timing advance. The preset value can be indicated by at least one of the sidelink radio resource control signaling, the medium access control-control element, the sidelink control information, and the random access response message. The preset value can be used as one of the parameters for selecting or determining the cyclic prefix extension.

In an embodiment, the first timing advance is applied to the first transmission of two adjacent transmissions.

In an embodiment, the second timing advance is applied to the second transmission of two adjacent transmissions.

In an embodiment, the timing advance is indicated by at least one of the sidelink radio resource control signaling, the medium access control-control element, the sidelink control information, and the random access response message.

In this embodiment, through the above solution, the first timing advance and/or the second timing advance for two adjacent transmissions is selected or determined, the first timing advance is selected or determined based on at least one of the sidelink radio resource control signaling, the medium access control-control element and the sidelink control information sent by the first terminal; the first timing advance and/or the second timing advance is selected or determined based on the medium access control-control element sent by the network device; the second timing advance is selected or determined based on the random access response message sent by the network device. Furthermore, the cyclic prefix extension is selected or determined based on the first timing advance and/or the second timing advance for sidelink channel transmission, which helps to reserve the channel occupancy time and improve the probability of occupying the unlicensed spectrum during the sidelink transmission process.

Referring to FIG. 10, FIG. 10 is a schematic flowchart of a processing method according to an embodiment of the present application. The method of the embodiment of the present application can be executed by a terminal device (such as a mobile phone, a vehicle, etc.), and the processing method includes the following steps:
S10: sending a first message, where the first message is configured to select or determine a first parameter, and the first parameter is configured to select or determine a cyclic prefix extension.

In an embodiment of the present application, a first message is sent to a receiving terminal and/or a second transmitting terminal by a first transmitting terminal, so that the receiving terminal and/or the second transmitting terminal select or determine a first parameter according to the first message, use the first parameter to select or determine a cyclic prefix extension, and generate an orthogonal frequency division multiplexing symbol according to the cyclic prefix extension for communication.

In an embodiment, the first message includes at least one of the following: sidelink control information, common sidelink control information, sidelink radio resource control signaling, sidelink medium access control-control element.

In an embodiment, the first parameter includes at least one of the following: number of symbols, first timing advance, gap value.

In an embodiment, the step of selecting or determining the first parameter based on the first message includes at least one of the following:
selecting or determining the number of symbols based on the sidelink control information, downlink control information, common sidelink control information, the subcarrier spacing of the current sidelink Bandwidth Part and/or the sidelink resource pool;
selecting or determining the first timing advance based on at least one of the sidelink radio resource control signaling, sidelink medium access control-control element and sidelink control information sent by the first transmitting terminal;
selecting or determining the propagation delay based on the sidelink radio resource control signaling, a preset fixed value and/or the first signal;
selecting or determining the gap value based on the sidelink control information.

In an embodiment, after the step S10, the method further includes: in response to the number of symbols being greater than a preset threshold, discarding the symbol of the previous transmission in two adjacent transmissions.

In an embodiment of the present application, when the number of symbols Cᵢ is greater than 1, the first transmitting terminal discards the last Cᵢ-1 symbols of the last transmission.

In an embodiment, before the step S10, the method further includes: selecting or determining the first message based on the second message.

In an embodiment of the present application, the first transmitting terminal can receive a second message sent by a network device (such as a base station), and the first transmitting terminal can forward the first timing advance carried in the second message from the base station to the receiving terminal and/or the second transmitting terminal through the first message.

In this embodiment, through the above solution, by sending a first message including sidelink control information, common sidelink control information, sidelink radio resource control signaling and/or sidelink medium access control-control element, a first parameter including the number of symbols, a first timing advance and/or a gap value is selected or determined. The first parameter can select or determine a cyclic prefix extension, and the orthogonal frequency division multiplexing symbol generated according to the cyclic prefix extension can be used in the communication process to increase the probability of occupying unlicensed spectrum during the sidelink transmission process.

As shown in FIG. 11, FIG. 11 is a schematic flowchart of a processing method according to an embodiment of the present application. The method in this embodiment of the present application can be executed by a network device (such as a base station), and the processing method includes the following steps:
A10: sending a second message, where the second message is configured to select or determine a second parameter, and the second parameter is configured to select or determine a cyclic prefix extension.

In an embodiment of the present application, a second message is sent by a network device to select or determine a second parameter, and then a cyclic prefix extension is selected or determined based on the second parameter to generate a symbol for a communication process.

In an embodiment, the second message includes at least one of the following: downlink control information, a medium access control-control element, and a random access response message.

In an embodiment, the second parameter includes at least one of the following: the number of symbols, the timing advance, and the gap value.

In an embodiment, the timing advance includes a first timing advance and/or a second timing advance for two adjacent transmissions.

In an embodiment of the present application, based on the downlink control information, the medium access control-control element, and/or the random access response message in the second message, the method for selecting or determining the first parameter includes at least one of the following:
selecting or determining the number of symbols based on the downlink control information;
selecting or determining the gap value based on the downlink control information;
selecting or determining the first timing advance and/or the second timing advance based on the medium access control-control element;
selecting or determining the second timing advance based on the random access response message.

The embodiment of the present application adopts the above-mentioned solution, specifically by sending a second message to select or determine a second parameter, and then selects or determines a cyclic prefix extension based on the second parameter to generate symbols for the communication process, which helps to reserve channel occupancy time and increase the probability of occupying unlicensed spectrum during sidelink transmission.

Based on the above embodiments of the present application, the present application further provides a processing method.

In the embodiment of the present application, if there is no cell on the spectrum used for the sidelink communication, that is, the first transmitting terminal and the receiving terminal and/or the second transmitting terminal cannot communicate with the base station on the spectrum, the TA used by the first transmitting terminal and the receiving terminal and/or the second transmitting terminal is 0. Then the length of the CPE can be determined by the following formula.

$${T}_{CPE} = ( {T}_{2} - {T}_{1} ) + {T}_{d} - {T}_{gap} = {\sum }_{{0}^{Ci}} {T}_{sym} - ( {T}_{gap} - {T}_{d} )$$

T_{sym} is the symbol length, Cᵢ is the number of symbols, and T_{gap} is the gap value.

For the next transmission, in order to determine the length of CPE T_{CPE}, it is necessary to select or determine the number of symbols Cᵢ, the propagation delay T_{d}, and the gap value T_{gap}.

In an embodiment of the present application, the number of symbols Cᵢ can be dynamically indicated by SCI. In an embodiment, a field is added to the SCI format to indicate the number of symbols required for the cyclic prefix extension, for example, 2 bits are added, and the field points to the above Table 1. The Cᵢ values in the table are C₁, C₂, and C₃, respectively, C₁=1 for μ∈{0,1}, C₁=2 for μ=2; C₂ and C₃ are configured by RRC signaling, and their values are {1, . . . , 28}. When the subcarrier spacing is 15 kHz, the values of C₂ and C₃ are {1, . . . , 28}; When the subcarrier spacing is 30 kHz, the value of C₂ is {1, . . . , 28}, and the value of C₃ is {2, . . . , 28}; when the subcarrier spacing is 60 kHz, the value of C₂ is {2, . . . , 28}, and the value of C₃ is {3, . . . , 28}.

In an embodiment, the symbol number Cᵢ can be dynamically indicated by a common SCI, and the common SCI is configured to indicate at least one of the COT length, the COT remaining time, the COT switching point, the symbol number Cᵢ, the channel access type, etc.

In an embodiment, the symbol number Cᵢ is associated with the subcarrier spacing of the current sidelink BWP and/or the sidelink resource pool, for example, when the subcarrier spacing is 15 kHz and 30 kHz, Cᵢ is equal to 1; when the subcarrier spacing is 60 kHz, Cᵢ is equal to 2.

In an embodiment, when the symbol number Cᵢ is greater than 1, the transmitting terminal discards the last Cᵢ-1 symbols of the last transmission.

In the embodiment of the present application, for the propagation delay, considering that the sidelink is mainly applied to two scenarios, one is the indoor scenario, the distance between the terminals is small, and the corresponding propagation delay is also small; the other is the highway scenario, the distance between the terminals is large, and the corresponding propagation delay is also large.

In an embodiment, the propagation delay can be disabled by RRC signaling, that is, the cyclic prefix extension calculation does not need to consider the propagation delay.

In an embodiment, a fixed propagation delay value is used, such as 1 μs, 2 μs, etc.

In an embodiment, the receiving terminal and/or the second transmitting terminal corresponding to the next transmission needs to estimate the propagation delay based on the received signal. The signal is sent by the first transmitting terminal corresponding to the previous transmission, and the signal can be at least one of the DMRS of the PSCCH channel, the DMRS of the PSSCH channel, the sidelink synchronization signal, and the sidelink CSI-RS signal.

In the embodiment of the present application, the gap value is 16 μs and/or 25 μs, which can be dynamically indicated by SCI.

In an embodiment, if the subsequent transmission is a sidelink physical feedback channel sent by the receiving terminal, the number of symbols, gap value and other parameters can be indicated by SCI.

In an embodiment, if the subsequent transmission is at least one of the physical sidelink control channel and/or physical sidelink shared channel, physical sidelink feedback channel, physical sidelink synchronization signal/physical sidelink broadcast channel block (S-SS/PSBCH), and sidelink channel state information reference signal (SL-CSI-RS) sent by the second transmitting terminal, the number of symbols, gap value and other parameters can be indicated by SCI.

In an embodiment, the above parameters, such as the number of symbols and the gap value, can also be jointly indicated by SCI, for example, configuring a table, each row in the table represents a value of the above parameters. The table can be configured by RRC signaling.

In an embodiment, the gap value, which is 16 μs and/or 25 μs, can be predefined.

In an embodiment, the cyclic prefix extension is configured to generate OFDM symbols. In an embodiment, for an OFDM symbol using cyclic prefix extension, the length of CPE is added before the cyclic prefix CP to generate an OFDM symbol.

In an embodiment of the present application, there is no cell on the spectrum used for sidelink communication, that is, the first transmitting terminal and the receiving terminal and/or the second transmitting terminal cannot communicate with the base station on the spectrum. When the timing advance TA used by the first transmitting terminal and the receiving terminal and/or the second transmitting terminal is 0, the cyclic prefix extension is determined by selecting or determining the number of symbols Cᵢ, the propagation delay T_{d} and the gap value, and then the orthogonal frequency division multiplexing symbol is generated according to the cyclic prefix extension. Then the sidelink channel transmission is performed based on the orthogonal frequency division multiplexing symbol, which helps to reserve the channel occupancy time and improve the probability of occupying the unlicensed spectrum during the sidelink transmission process. The determination method of the cyclic prefix extension in different application scenarios is expanded, and the flexibility of the determination method of the cyclic prefix extension is improved.

Based on the above embodiments of the present application, the present application further discloses a processing method.

In the embodiment of the present application, for the continuous multiple transmissions of the first transmitting terminal, considering that in the current Sidelink slot structure, there is always a gap symbol at the end of the slot for Tx/Rx switching (and when the UE accesses the network in RRC connected state, it switches to UL transmission through TA). Cyclic prefix extension technology is required to ensure that the length of the interval is equal to 16/25 μs or less than 16 μs. When using cyclic prefix extension, the length of the cyclic prefix extension needs to be determined. Since the two consecutive transmissions are from the same transmitting terminal, there is no need to consider the transmission propagation delay.

The length of CPE T_{CPE} can be obtained by the following equation:

$${T}_{1} - {TA}_{old} + {T}_{gap} = {T}_{2} - {TA}_{new} - {T}_{CPE}$$

T₁ is the end time of the previous transmission, T₂ is the start time of the next transmission, TA_{old} is the timing advance of the previous transmission, and TA_{new} is the timing advance of the next transmission.

Through conversion, the following can be obtained.

$${T}_{CPE} = ( {T}_{2} - {T}_{1} ) - ( {TA}_{new} - {TA}_{old} ) - {T}_{gap} = {\sum }_{{0}^{Ci}} {T}_{sym} - ( {TA}_{new} - {TA}_{old} ) - {T}_{gap} = {\sum }_{{0}^{Ci}} {T}_{sym} - ( ( {TA}_{new} - {TA}_{old} ) + {T}_{gap} )$$

T_{sym} is the symbol length, Cᵢ is the number of symbols, and T_{gap} is the gap value, TA_{old}=(N_{TA,SL}+N_{TA,offset})·T_{c}; TA_{new}=(N_{TA,SL}+N_{TA,offset})·T_{c}

For the next transmission, in order to determine the size of CPE, it is necessary to select or determine the number of symbols Cᵢ, the timing advance TA_{old} corresponding to the previous transmission, the timing advance TA_{new} corresponding to the next transmission, and the gap value T_{gap}.

In an embodiment of the present application, the number of symbols Cᵢ can be dynamically indicated by DCI. In an embodiment, a field is added to the DCI format to indicate the number of symbols required for the cyclic prefix. For example, 2 bits are added, and the field points to the above Table 1. The Cᵢ values in the table are C₁, C₂, and C₃, respectively, C₁=1 for μ∈{0,1}, C₁=2 for μ=2; C₂ and C₃ are configured by RRC signaling, and their values are {1, . . . , 28}. When the subcarrier spacing is 15 kHz, the values of C₂ and C₃ are {1, . . . , 28}; when the subcarrier spacing is 30 kHz, the values of C₂ are {1, . . . , 28}, and the values of C₃ are {2, . . . , 28}; when the subcarrier spacing is 60 kHz, the values of C₂ are {2, . . . , 28}, and the values of C₃ are {3, . . . , 28}.

In an embodiment, the symbol number Cᵢ is associated with the subcarrier spacing of the current sidelink BWP and/or the sidelink resource pool, for example, when the subcarrier spacing is 15 kHz and 30 kHz, Cᵢ is equal to 1; when the subcarrier spacing is 60 kHz, Cᵢ is equal to 2.

In an embodiment, when the symbol number Cᵢ is greater than 1, the transmitting terminal discards the last Cᵢ-1 symbols of the last transmission.

In an embodiment of the present application, the TA_{old} corresponding to the previous transmission and the TA_{new} corresponding to the next transmission can be obtained through the MAC-CE from the base station.

In an embodiment of the present application, for the timing advance TA_{old} corresponding to the previous transmission, the timing advance TA_{old} is the timing advance used by the previous transmission of the transmitting terminal, and the timing advance is equal to TA_{old}=(N_{TA,SL}+N_{TA,offset})·T_{c}, N_{TA,SL} can be equal to the uplink timing advance N_{TA}_old of the currently operating cell. T_{A} is obtained through RAR message or MAC-CE. N_{TA,offset} is obtained through RRC signaling indication or predefined.

In an embodiment, N_{TASL} can be equal to zero.

In an embodiment, TA_{old} can notify the terminal corresponding to the previous transmission via a MAC-CE sent by the base station.

In an embodiment, TA_{old} can notify the terminal corresponding to the previous transmission via a RAR message sent by the base station.

In an embodiment of the present application, for the timing advance TA_{new} corresponding to the next transmission, the timing advance TA_{new} is the timing advance used by the transmission of the transmitting terminal, and the timing advance is equal to TA_{new}=(N_{TASL}+N_{TA,offset})·T_{c}, N_{TA,SL} can be equal to the uplink timing advance N_{TA_old} of the currently operating cell. T_{A} is obtained through RAR message or MAC-CE. N_{TA,offset} is obtained through RRC signaling indication or predefined.

In an embodiment, the timing advance TA_{new} is the timing advance used for the next transmission, and the next transmission and the previous transmission are in the same COT.

In an embodiment, N_{TASL} can be equal to zero.

In an embodiment, TA_{new} can notify the terminal corresponding to the next transmission through the MAC-CE sent by the base station.

In an embodiment, TA_{new} can notify the terminal corresponding to the next transmission through the RAR message sent by the base station.

In the embodiment of the present application, for the gap value, its value is X μs, 16 μs and/or 25 μs, which can be dynamically indicated by DCI, where X is a value less than 16, and the value of X can be configured by RRC.

In an embodiment, if the DCI indicates that the gap value is X μs, the transmitting terminal does not need to perform LBT when sending at least one of the subsequent physical sidelink control channel and/or physical sidelink shared channel, physical sidelink feedback channel, physical sidelink synchronization signal/physical sidelink broadcast channel block (S-SS/PSBCH block), and sidelink channel state information reference signal (SL-CSI-RS); otherwise, LBT is performed once.

In an embodiment, for the gap value, its value is 16 μs and/or 25 μs, which can be dynamically indicated by DCI.

In an embodiment, the above parameters, such as the number of symbols and the gap value, can also be jointly indicated by DCI, such as configuring a table, each row in the table represents a value of the above parameters. The table can be configured by RRC signaling.

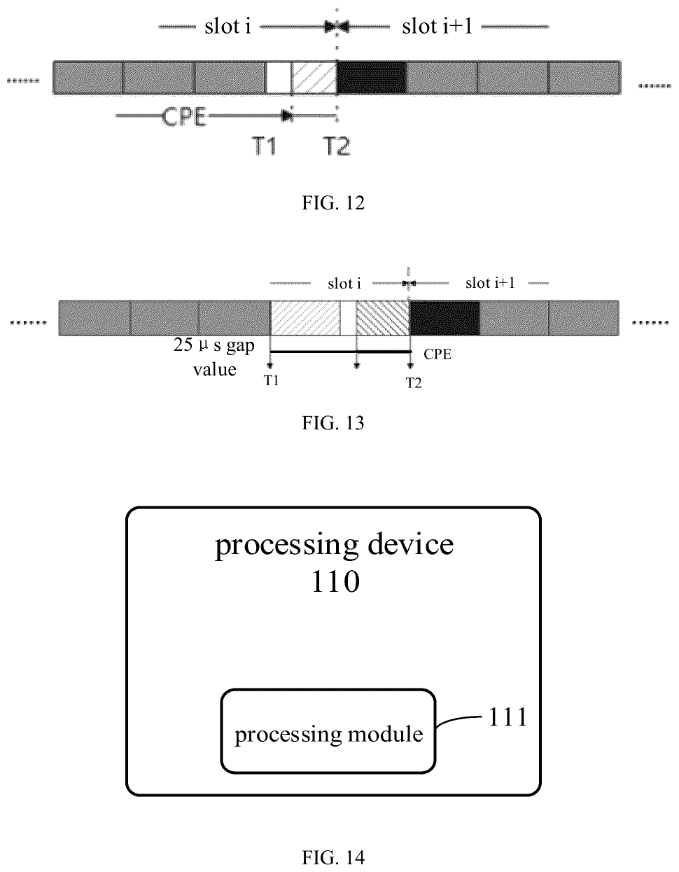

As shown in FIG. 12 and FIG. 13, FIG. 12 is a first principle schematic diagram of a processing method according to an embodiment of the present application, and FIG. 13 is a second principle schematic diagram of a processing method according to an embodiment of the present application. The cyclic prefix extension is applied to generate an OFDM symbol. In an embodiment, for an OFDM symbol using cyclic prefix extension, the length of CPE is added before the cyclic prefix CP to generate an OFDM symbol.

In an embodiment of the present application, when the first terminal has multiple consecutive transmissions, since the two consecutive transmissions are from the same transmitting terminal, there is no need to consider the transmission propagation delay. By selecting or determining the number of symbols Cᵢ, the timing advance TA_{old} corresponding to the previous transmission, the timing advance TA_{new} corresponding to the next transmission and the gap value, the cyclic prefix extension is determined, and the orthogonal frequency division multiplexing symbol is generated based on the cyclic prefix extension. The sidelink channel transmission is performed based on the orthogonal frequency division multiplexing symbol, which helps to reserve the channel occupancy time and improve the probability of occupying the unlicensed spectrum during the sidelink transmission process. The determination method of the cyclic prefix extension in different application scenarios is expanded, and the flexibility of the determination method of the cyclic prefix extension is improved.

As shown in FIG. 14, FIG. 14 is a first schematic structural diagram of a processing device according to an embodiment of the present application. The device may be mounted on a terminal device in the above method embodiment, and the device may specifically be a server. The processing device shown in FIG. 14 may be used to perform some or all of the functions in the method embodiment described in the above embodiment. As shown in FIG. 14, the processing device 110 includes: a processing module 111, configured for selecting or determining a cyclic prefix extension based on a preset parameter, generating an orthogonal frequency division multiplexing symbol based on the cyclic prefix extension, and communicating based on the orthogonal frequency division multiplexing symbol.

In an embodiment, the preset parameter includes at least one of the following: a number of symbols, a timing advance, a propagation delay, and a gap value.

In an embodiment, before selecting or determining the cyclic prefix extension based on the preset parameter, generating the orthogonal frequency division multiplexing symbol based on the cyclic prefix extension, and communicating based on the orthogonal frequency division multiplexing symbol, the method further includes:
selecting or determining at least one of the following: a number of symbols, a timing advance, a propagation delay, and a gap value.

In an embodiment, a way of selecting or determining the number of symbols includes at least one of the following:
selecting or determining the number of symbols based on sidelink control information;
selecting or determining the number of symbols based on downlink control information;
selecting or determining the number of symbols based on common sidelink control information; and
selecting or determining the number of symbols based on a subcarrier spacing of a current sidelink Bandwidth Part and/or a sidelink resource pool.

In an embodiment, the timing advance includes a first timing advance and/or a second timing advance for two adjacent transmissions, and a way of selecting or determining the timing advance includes at least one of the following:
selecting or determining the first timing advance based on at least one of a sidelink radio resource control signaling, a medium access control-control element and sidelink control information sent by the first terminal;
selecting or determining the first timing advance and/or the second timing advance based on a medium access control-control element sent by the network device (such as a base station); and
selecting or determining the second timing advance based on a random access response message sent by the network device (such as a base station).

In an embodiment, a way of selecting or determining the propagation delay includes at least one of the following:
selecting or determining the propagation delay based on radio resource control signaling;
selecting or determining the propagation delay based on a preset fixed value; and
selecting or determining the propagation delay based on a first signal.

In an embodiment, the selecting or determining the gap value includes at least one of the following:
selecting or determining the gap value based on sidelink control information;
selecting or determining the gap value based on downlink control information; and
selecting or determining the gap value based on a preset configuration.

Some steps involved in the processing method according to the embodiment of the present application can be executed by the modules in the processing device shown in FIG. 14. The various units in the processing device shown in FIG. 14 can be respectively or completely combined into one or several other modules to constitute, or one (some) of the modules can be further divided into multiple functionally smaller units to constitute, which can achieve the same operation without affecting the realization of the technical effects of the embodiment of the present application. The above-mentioned units are divided based on logical functions. In practical applications, the functions of one module can also be realized by multiple modules, or the functions of multiple modules can be realized by one module. In other embodiments of the present application, the processing device can also include other modules. In practical applications, these functions can also be implemented with the assistance of other modules, and can be implemented by the collaboration of multiple modules.

The processing device provided in the embodiment of the present application can execute the technical solution shown in the above method embodiment, and its implementation principle and beneficial effects are similar, which will not be repeated here.

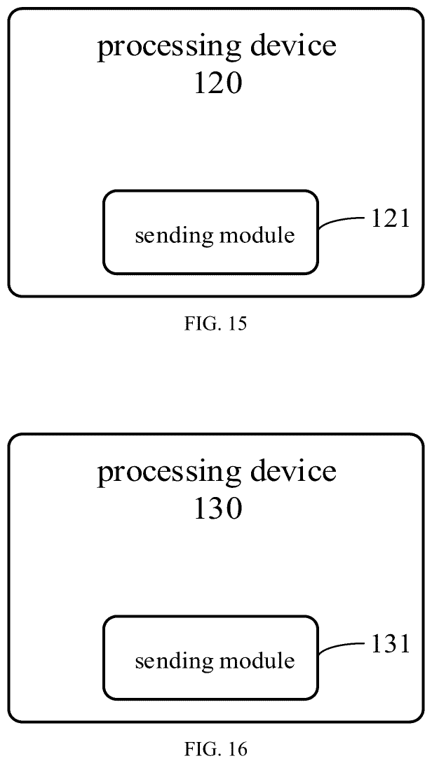

As shown in FIG. 15, FIG. 15 is a second schematic structural diagram of a processing device according to an embodiment of the present application. The processing device 120 includes: a sending module 121 configured for sending a first message, where the first message is configured to select or determine a first parameter, and the first parameter is configured to select or determine a cyclic prefix extension.

In an embodiment, the first message includes at least one of the following: sidelink control information, common sidelink control information, a sidelink radio resource control signaling, and a sidelink medium access control-control element.

In an embodiment, the first parameter includes at least one of the following: a number of symbols, a first timing advance, and a gap value.

In an embodiment, after sending the first message, the method further includes: in response to the number of symbols being greater than a preset threshold, discarding a symbol of a previous transmission in two adjacent transmissions.

In an embodiment, the processing device is further configured for sending a first signal, where the first signal is configured to select or determine a propagation delay.

The processing device provided in the embodiment of the present application can execute the technical solution shown in the above method embodiment, and its implementation principle and beneficial effects are similar, which will not be repeated here.

FIG. 16 is a third schematic structural diagram of a processing device according to an embodiment of the present application. As shown in FIG. 16, the processing device 130 includes a sending module 131 configured for sending a second message, where the second message is configured to select or determine a second parameter, and the second parameter is configured to select or determine a cyclic prefix extension.

In an embodiment, the second message includes at least one of the following: downlink control information, a medium access control-control element, a random access response message.

In an embodiment, the second parameter includes at least one of the following: a number of symbols, a timing advance, and a gap value.

In an embodiment, the timing advance includes a first timing advance and/or a second timing advance for two adjacent transmissions.

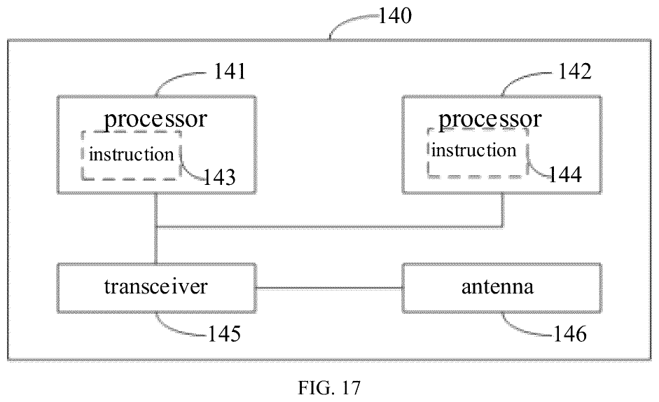

Referring to FIG. 17, which is a schematic structural diagram of the communication device according to an embodiment of the present application. As shown in FIG. 17, the communication device 140 described in this embodiment can be the terminal device (or a component that can be used for the terminal device) or the network device (or a component that can be used for the network device) mentioned in the above method embodiment. The communication device 140 can be used to implement the method corresponding to the terminal device or the network device described in the above method embodiment, and specifically refer to the description in the above method embodiment.

The communication device 140 may include one or more processors 141, which may also be referred to as a processing unit, and may implement certain control or processing functions. The processor 141 may be a general-purpose processor or a dedicated processor, etc. For example, it may be a baseband processor or a central processing unit. The baseband processor may be used to process the communication protocol and communication data, and the central processing unit may be used to control the communication device, execute the software program, and process the data of the software program.

In an embodiment, the processor 141 may also store instructions 143 or data (such as intermediate data). The instructions 143 may be executed by the processor 141, so that the communication device 140 executes the method corresponding to the terminal device or network device described in the above method embodiment.

In an embodiment, the communication device 140 may include a circuit, which may implement the function of sending or receiving or communicating in the above method embodiment.

In an embodiment, the communication device 140 may include one or more memories 142, on which instructions 144 may be stored, and the instructions may be executed on the processor 141, so that the communication device 140 executes the method described in the above method embodiment.

In an embodiment, data may also be stored in the memory 142. The processor 141 and the memory 142 may be set separately or integrated together.

In an embodiment, the communication device 140 may also include a transceiver 145 and/or an antenna 146. The processor 141 may be called a processing unit, which controls the communication device 140 (terminal device or core network device or wireless access network device). The transceiver 145 may be referred to as a transceiver unit, a transceiver, a transceiver circuit, or a transceiver, etc., and is used to implement the transceiver function of the communication device 140.

In an embodiment, if the communication device 140 is used to implement the operation corresponding to the terminal device in the above embodiments, for example, the transceiver 145 may receive or send the first message and the second message; and the processor 141 may select or determine the time domain position and/or frequency domain position of each transmission opportunity of the control resource set based on the preset content.

In an embodiment, the specific implementation process of the processor 141 and the transceiver 145 can refer to the relevant description of the above embodiments, which will not be repeated here.

In an embodiment, if the communication device 140 is used to implement the operation corresponding to the network device in the above embodiments, for example: the transceiver 145 may receive or send the first message and the second message.

In an embodiment, the specific implementation process of the processor 141 and the transceiver 145 can refer to the relevant description of the above embodiments, which will not be repeated here.

The processor 141 and transceiver 145 described in the present application can be implemented in an Integrated Circuit (IC), an analog integrated circuit, a Radio Frequency Integrated Circuit (RFIC), a mixed signal integrated circuit, an Application Specific Integrated Circuit (ASIC), a Printed Circuit Board (PCB), an electronic device, etc. The processor 141 and the transceiver 145 can also be manufactured using various integrated circuit process technologies, such as Complementary Metal Oxide Semiconductor (CMOS), N Metal-Oxide-Semiconductor (NMOS), Positive channel Metal Oxide Semiconductor (PMOS), Bipolar Junction Transistor (BJT), bipolar CMOS (BiCMOS), silicon germanium (SiGe), gallium arsenide (GaAs), etc.

In the present application, the communication device may be a terminal device (such as a mobile phone) or a network device (such as a base station), which needs to be determined according to the context. In addition, the terminal device may be implemented in various forms. For example, the terminal device described in the present application may include mobile terminals such as mobile phones, tablet computers, laptops, PDAs, portable media players (PMPs), navigation devices, wearable devices, smart bracelets, pedometers, etc., as well as fixed terminal devices such as digital TVs and desktop computers.

Although in the above embodiment description, the communication device is described as a terminal device or a network device, the scope of the communication device described in the present application is not limited to the above terminal devices or network devices, and the structure of the communication device may not be limited to FIG. 17. The communication device may be an independent device or may be part of a larger device.

The embodiment of the present application also provides a communication system, including: a terminal device in any of the above method embodiments; and a network device in any of the above method embodiments.

The embodiment of the present application also provides a communication device, including a memory and a processor, a processing program is stored on the memory, and the processing program implements the steps of the processing method in any of the above embodiments when it is executed by the processor. The communication device in the present application can be a terminal device (such as a mobile phone) or a network device (such as a base station), and the specific reference needs to be clarified according to the context.

The embodiment of the present application also provides a storage medium, a processing program is stored on the storage medium, and the processing program implements the steps of the processing method in any of the above embodiments when it is executed by the processor.

In the embodiment of the communication device and computer-readable storage medium provided in the embodiment of the present application, all technical features of any of the above processing method embodiments may be included, and the expansion and explanation content of the specification are basically the same as the embodiments of the above methods, and will not be repeated here.

The embodiment of the present application also provides a computer program product, which includes a computer program code. When the computer program code is run on a computer, the computer executes the method in the above various possible implementations.

The embodiment of the present application also provides a chip, including a memory and a processor, the memory is used to store a computer program, and the processor is used to call and run the computer program from the memory, so that the device equipped with the chip executes the methods in various possible implementations as described above.

It can be understood that the above scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are only for description and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terms, concepts, technical solutions and/or application scenario descriptions are generally described in detail only the first time they appear. When it appears again later, for the sake of brevity, it is generally not repeated. When understanding the technical solutions and other content of the present application, the same or similar term concepts, technical solutions and/or application scenario descriptions that are not described in detail later can refer to the relevant previous detailed descriptions.

In the present application, each embodiment is described with its own emphasis. For parts that are not detailed or recorded in a certain embodiment, please refer to the relevant descriptions of other embodiments.

The technical features of the technical solution of the present application can be combined in any way. To simplify the description, all possible combinations of the technical features in the above embodiments are not described. However, as long as there is no contradiction in the combination of these technical features, it should be considered to be within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
selecting or determining a cyclic prefix extension based on a preset parameter, generating an orthogonal frequency division multiplexing symbol based on the cyclic prefix extension, and communicating based on the orthogonal frequency division multiplexing symbol;
wherein the preset parameter comprises a number of symbols and a gap value.

2. The method according to claim 1, wherein:
the preset parameter further comprises at least one of the following: a timing advance, and a propagation delay; and/or
before selecting or determining the cyclic prefix extension based on the preset parameter, generating the orthogonal frequency division multiplexing symbol based on the cyclic prefix extension, and communicating based on the orthogonal frequency division multiplexing symbol, the method further comprises: selecting or determining at least one of the following: the number of symbols, a timing advance, the propagation delay, and the gap value.

3. The method according to claim 2, wherein a way of selecting or determining the number of symbols comprises at least one of the following:
selecting or determining the number of symbols based on sidelink control information;
selecting or determining the number of symbols based on downlink control information;
selecting or determining the number of symbols based on common sidelink control information; and
selecting or determining the number of symbols based on a subcarrier spacing of a current sidelink Bandwidth Part and/or a sidelink resource pool.

4. The method according to claim 2, wherein the timing advance comprises a first timing advance and/or a second timing advance for two adjacent transmissions, and a way of selecting or determining the timing advance comprises at least one of the following:
selecting or determining the first timing advance based on at least one of a sidelink radio resource control signaling, a medium access control-control element and sidelink control information sent by the first terminal;
selecting or determining the first timing advance and/or the second timing advance based on a medium access control-control element sent by the network device; and
selecting or determining the second timing advance based on a random access response message sent by the network device.

5. The method according to claim 2, wherein a way of selecting or determining the propagation delay comprises at least one of the following:
selecting or determining the propagation delay based on radio resource control signaling;
selecting or determining the propagation delay based on a preset fixed value; and
selecting or determining the propagation delay based on a first signal.

6. The method according to claim 2, wherein the selecting or determining the gap value comprises at least one of the following:
selecting or determining the gap value based on sidelink control information;
selecting or determining the gap value based on downlink control information; and
selecting or determining the gap value based on a preset configuration.

7. A processing method, comprising:
sending a first message, wherein the first message is configured to select or determine a first parameter, and the first parameter is configured to select or determine a cyclic prefix extension;
wherein the first parameter comprises a number of symbols and a gap value.

8. The method according to claim 7, wherein the first message comprises at least one of the following: sidelink control information, common sidelink control information, a sidelink radio resource control signaling, and a sidelink medium access control-control element; and/or, the first parameter further comprises a first timing advance.

9. The method according to claim 8, wherein after sending the first message, the method further comprises:
in response to the number of symbols being greater than a preset threshold, discarding symbols of a previous transmission in two adjacent transmissions.

10. The method according to claim 7, further comprising:
sending a first signal, wherein the first signal is configured to select or determine a propagation delay.

11. The method according to claim 7, wherein before sending the first message, the method further comprises:
selecting or determining the first message based on a second message.

12. A processing method, comprising:
sending a second message, wherein the second message is configured to select or determine a second parameter, and the second parameter is configured to select or determine a cyclic prefix extension.

13. The method according to claim 12, wherein the second message comprises at least one of the following: downlink control information, a medium access control-control element, a random access response message; and/or the second parameter comprises at least one of the following: a number of symbols, a timing advance, and a gap value.

14. The method according to claim 13, wherein the timing advance comprises a first timing advance and/or a second timing advance for two adjacent transmissions.

15. A communication device, comprising: a memory, a processor, and a processing program stored on the memory and executable on the processor, wherein the processing program implements the processing method according to claim 1 when executed by the processor.

16. A communication device, comprising: a memory, a processor, and a processing program stored on the memory and executable on the processor, wherein the processing program implements the processing method according to claim 7 when executed by the processor.

17. A communication device, comprising: a memory, a processor, and a processing program stored on the memory and executable on the processor, wherein the processing program implements the processing method according to claim 12 when executed by the processor.

18. A non-transitory computer-readable storage medium, wherein a computer program is stored on the non-transitory computer-readable storage medium, and the computer program implements the processing method according to claim 1 when executed by the processor.

19. A non-transitory computer-readable storage medium, wherein a computer program is stored on the non-transitory computer-readable storage medium, and the computer program implements the processing method according to claim 7 when executed by the processor.

20. A non-transitory computer-readable storage medium, wherein a computer program is stored on the non-transitory computer-readable storage medium, and the computer program implements the processing method according to claim 12 when executed by the processor.
